(19) United States
(12) Patent Application Publication
(10) Pub. No.: US 2023/0383961 A1
(43) Pub. Date: Nov. 30, 2023

(54) COOKING APPARATUS

(71) Applicant: SAMSUNG ELECTRONICS CO., LTD., Suwon-si (KR)

(72) Inventors: Sangjin KIM, Suwon-si (KR); Myoungkeun KWON, Suwon-si (KR); Changhoon OH, Suwon-si (KR); Sangjin LEE, Suwon-si (KR); Eungryeol SEO, Suwon-si (KR); Qasim KHAN, Suwon-si (KR)

(21) Appl. No.: 18/231,075

(22) Filed: Aug. 7, 2023

Related U.S. Application Data
(63) Continuation of application No. PCT/KR2022/001992, filed on Feb. 9, 2022.

(30) Foreign Application Priority Data
Feb. 9, 2021 (KR) 10-2021-0018336
Feb. 9, 2022 (KR) 10-2022-0016778

(51) Int. Cl. F24C 15/20

(52) U.S. Cl. CPC F24C 15/2042; F24C 15/2035

(57) ABSTRACT

A cooking apparatus is disclosed. The cooking apparatus according to an embodiment of the present disclosure may comprise: an outer case with a lower surface including a first inlet hole and a second inlet hole; an inner case which is accommodated in the outer case and in which a cooking chamber is formed; a fan which is disposed above the first inlet hole and suctions air introduced through the first inlet hole so as to allow air to be suctioned through the first and second inlet holes; and a rear flow channel which is formed at the rear of the inner case to communicate with the fan so as to allow air suctioned through the first inlet hole to be guided to the fan.

### CROSS-REFERENCE TO RELATED APPLICATIONS

This application is a bypass continuation of International Application No. PCT/KR2022/001992, filed Feb. 9, 2022, which claims priority to Korean Patent Application No. 10-2021-0018336, filed Feb. 9, 2021, and Korean Patent Application No. 10-2022-0016778, filed Feb. 9, 2022, the disclosures of which are herein incorporated by reference in their entirety.

### BACKGROUND

### 1. Field

The present disclosure relates to a cooking apparatus, and more particularly to a cooking apparatus with increased space utilization.

### 2. Description of Related Art

A cooking apparatus refers to a device for heating and cooking a cooking object, such as food, which may provide various functions related to cooking, such as heating, defrosting, drying, and sterilizing the cooking object. Such cooking apparatus includes, for example, an oven, such as a gas oven or an electric oven, a microwave heating device (hereinafter referred to as a microwave), a gas range, an electric range, a wall-mounted microwave oven (over the range), a gas grill, or an electric grill.

In particular, a wall-mounted microwave oven is a device that combines a microwave oven and a hood. In a conventional wall-mounted microwave oven, a fan that suctions air to discharge air to the outside is placed on the upper rear side of the microwave oven, or a fan that discharges air to the outside is placed on each side of the inner case.

When the fan is placed at the upper rear side of the microwave oven, the suction efficiency may decrease, and when the fan is placed on both sides, the internal structure of the microwave oven becomes complicated and the production cost increases.

### SUMMARY

One aspect of the present disclosure provides a cooking apparatus with high air intake efficiency.

Another aspect of the present disclosure provides a cooking apparatus with a simple internal structure and reduced production costs.

According to an embodiment of the disclosure, there is provided a cooking apparatus including: an outer case with a lower surface including a first inlet hole and a second inlet hole; an inner case accommodated within the outer case and in which a cooking chamber is formed; a fan disposed on an upper side of the first inlet hole and configured to suction air introduced into the first inlet hole such that air is suctioned through the first inlet hole and the second inlet hole; and a rear flow path formed at a rear of the inner case in communication with the fan such that air suctioned through the second inlet hole is guided to the fan.

The cooking apparatus may further include a sub fan in communication with one side of the rear flow path and disposed on an upper side of the second inlet hole such that air passed through the second inlet hole is introduced into the rear flow path.

The sub fan may be disposed at a rear side of the inner case to be in communication with the rear flow path.

One end of the rear flow path may be in communication with the fan and the other end of the rear flow path is in communication with the sub fan so that air discharged from the sub fan may flow to the fan via the rear flow path.

The cooking apparatus may further include a combining panel coupled to the fan and forming the one end of the rear flow path in communication with the fan.

The cooking apparatus may further include a flow path forming panel in contact with a rear wall of the inner case to form the rear flow path, wherein the combining panel may be combined with the flow path forming panel to form the one end of the rear flow path in communication with the fan.

The flow path forming panel may be provided in a plurality, wherein the plurality of flow path forming panels may include a first flow path forming panel disposed on an upper side of the combining panel, and a second flow path forming panel disposed on a lower side of the combining panel.

An outlet of the sub fan and an inlet of the fan may be formed between the first flow path forming panel and the second flow path forming panel.

The fan may include a plurality of inlets, wherein one of the plurality of inlets may be in communication with the rear flow path.

The cooking apparatus may further include: a first filter mounted on a bottom surface of the outer case to cover the first inlet hole and arranged adjacent to the fan so that a portion of the air passing through the first filter is directly suctioned into the fan; and a second filter mounted on a bottom surface of the outer case to cover the second inlet hole and may be arranged spaced apart from the fan so that a portion of the air passing through the second filter may be diverted into the rear flow path and suctioned into the fan.

The fan may be disposed between the outer case and the inner case such that air introduced into the outer case may be discharged to outside of the cooking apparatus.

The cooking apparatus may further include: a discharge panel disposed on an upper side of the fan, and provided with a hole having a shape corresponding to an outlet of the fan; a discharge flow path formed between the inner case and the outer case for air discharged from the discharge panel to flow; a guide panel formed with an upward slope at a corner of the outer case to guide air in the discharge flow path; and an outlet provided on an upper surface of the outer case for the guided air to flow out of the cooking apparatus.

According to an embodiment of the disclosure, there is provided a cooking apparatus including: an inner case forming a cooking chamber; an outer case accommodating the inner case and having a lower surface including a first inlet hole and a second inlet hole; a rear flow path formed at a rear of the inner case and configured to guide air suctioned into the second inlet hole; a flow path forming panel disposed between the inner case and the outer case at the rear to form the rear flow path; and a fan disposed on an upper side of the first inlet hole between the inner case and the outer case, configured to suction air which has passed through the first inlet hole, and disposed in communication with the rear flow path to suction air, which has passed through the second inlet hole, through the rear flow path.

The cooking apparatus may further include a sub fan disposed on an upper side of the second inlet hole between the inner case and the outer case.

The cooking apparatus may further include a combining panel, to which the fan is coupled, the combining panel coupled to the flow forming panel to form one end of the rear flow path that is in communication with the fan.

The flow path forming panel may be provided in a plurality, wherein the plurality of flow path forming panels may include a first flow path forming panel disposed on an upper side of the combining panel, and a second flow path forming panel disposed on a lower side of the combining panel.

An outlet of the sub fan and an inlet of the fan may be formed between the first flow path forming panel and the second flow path forming panel.

The inlet of the fan may be in communication with the one end of the rear flow path and the outlet of the sub fan may be in communication with the other end of the rear flow path.

According to an embodiment of the disclosure, there is provided a cooking apparatus including: an outer case having a lower surface including a first inlet hole and a second inlet hole; an inner case accommodated within the outer case and in which a cooking chamber is formed; a first filter and a second filter mounted on the outer case to cover the first inlet hole and the second inlet hole, respectively; a fan disposed on an outer side of the inner case such that air passed through at least one of the first inlet hole or the second inlet hole is suctioned; and a rear flow path formed at a rear of the inner case for air from at least one of the first inlet hole or the second inlet hole to be guided to the fan, wherein the first inlet hole is arranged adjacent to the fan such that air passing through the first inlet hole is directly suctioned into the fan, and the second inlet hole is arranged at a side of the first inlet hole such that air passing through the second inlet hole is divided to the rear flow path and suctioned into the fan.

The cooking apparatus may further include a flow path forming panel disposed at a rear of the inner case to form the rear flow path; and a sub fan disposed on an upper side of the second inlet hole while in communication with one end of the rear flow path such that air from at least one of the first inlet hole or the second inlet hole flow to the rear flow path.

According to an aspect of the present disclosure, a cooking apparatus with increased air intake efficiency can be provided by forming a rear flow path.

Furthermore, a cooking apparatus with a reduced production cost and a simplified structure can be provided by placing a minimum number of fans in an appropriate position.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view of an installed cooking apparatus according to one embodiment of the present disclosure.

FIG. 2 is a side view of a cooking apparatus according to one embodiment of the present disclosure.

FIG. 3 is a perspective view of a cooking apparatus according to one embodiment of the present disclosure.

FIG. 4 is an exploded perspective view of the cooking apparatus shown in FIG. 3.

FIG. 5 is a front view of the cooking apparatus shown in FIG. 3.

FIG. 6 is a perspective view of the cooking apparatus of FIG. 3, which is viewed from a rear top.

FIG. 7 is a perspective view of the cooking apparatus of FIG. 3, which is viewed from a rear bottom.

FIG. 8 is a diagram illustrating air flow in the cooking apparatus of FIG. 6.

FIG. 9 is a diagram illustrating air flow in the cooking apparatus shown in FIG. 7.

FIG. 10 is a rear view of air flow in a cooking apparatus according to one embodiment of the present disclosure.

FIG. 11 is a diagram illustrating air flow in a cooking apparatus according to one embodiment of the present disclosure, which is viewed from a side in which a fan unit is located.

FIG. 12 is an exploded perspective view of a cooking apparatus according to another embodiment of the present disclosure.

FIG. 13 is a front view of the cooking apparatus shown in FIG. 12.

FIG. 14 is a perspective view of the cooking apparatus shown in FIG. 12, which is viewed from a rear top.

FIG. 15 is a perspective view of the cooking apparatus of FIG. 12, which is viewed from a rear bottom

FIG. 16 is a diagram illustrating air flow in the cooking apparatus of FIG. 14.

FIG. 17 is a diagram illustrating air flow in the cooking apparatus shown in FIG. 15.

FIG. 18 is a rear view of air flow in a cooking apparatus according to another embodiment of the present disclosure.

FIG. 19 is a diagram illustrating air flow in a cooking apparatus according to another embodiment of the present disclosure, which is viewed from a side in which a fan unit is located.

FIG. 20 is a photograph analyzing an air flow distribution depending on formation of a rear flow path, which is obtained from a cross section taken along line A-A′ of FIG. 11.

### DETAILED DESCRIPTION

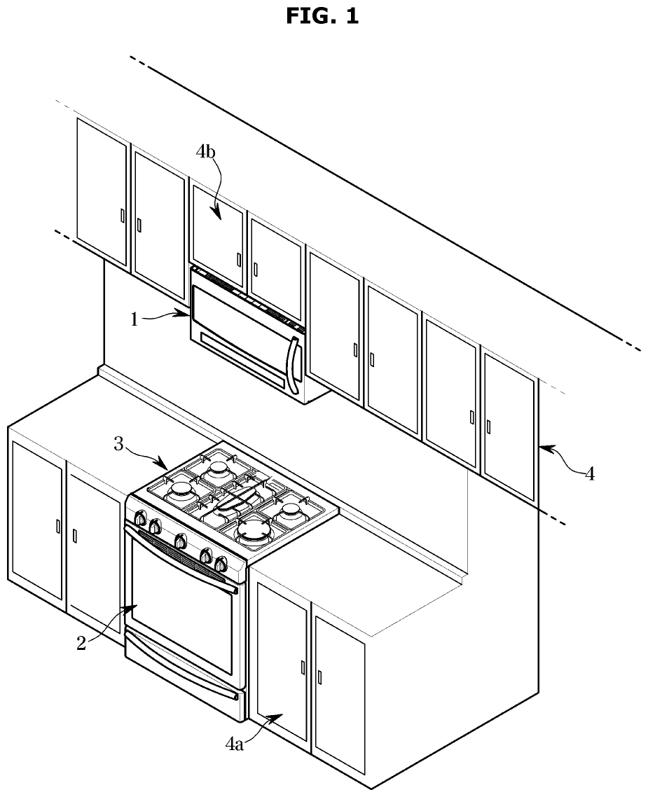

FIGS. 1 through 20, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments described herein and the configurations illustrated in the drawings are merely preferred examples of the disclosed disclosure, and there are many variations that may be made in place of the embodiments and drawings described herein at the time of filing of this application.

In addition, identical reference numerals or symbols in each drawing of this specification designate parts or components that perform substantially the same function.

Further, the terminology used herein is for the purpose of describing embodiments and is not intended to limit and/or define the disclosed disclosure. Expressions in the singular include the plural unless the context clearly indicates otherwise. As used herein, the terms “includes” or “has” are intended to designate the presence of the features, numbers, steps, actions, components, parts, or combinations thereof recited, and do not preclude the presence or addition of one or more other features, numbers, steps, actions, components, parts, or combinations thereof.

Further, as used herein, ordinal terms such as “first,” “second,” and the like may be used to describe various components, but the components are not limited by the terms, and the terms are used only to distinguish one component from another. For example, without departing from the scope of the present disclosure, a first component may be named as a second component, and similarly, a second component may be named as a first component. The term “and/or” includes a combination of a plurality of related recited items or any of a plurality of related recited items.

On the other hand, the terms “front,” “rear,” “left,” “right,” and the like used in the following description are defined with reference to the drawings, and the shape and position of each component are not limited by these terms.

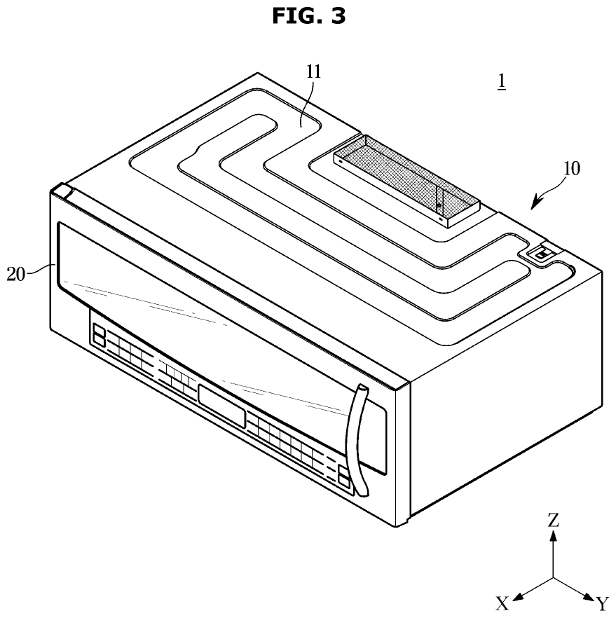

Specifically, as shown in FIG. 3, the direction in which the door 20 is shown is defined as forward, and with reference thereto, rear, left and right, and top and bottom are defined.

Embodiments will be described in more detail below with reference to the accompanying drawings.

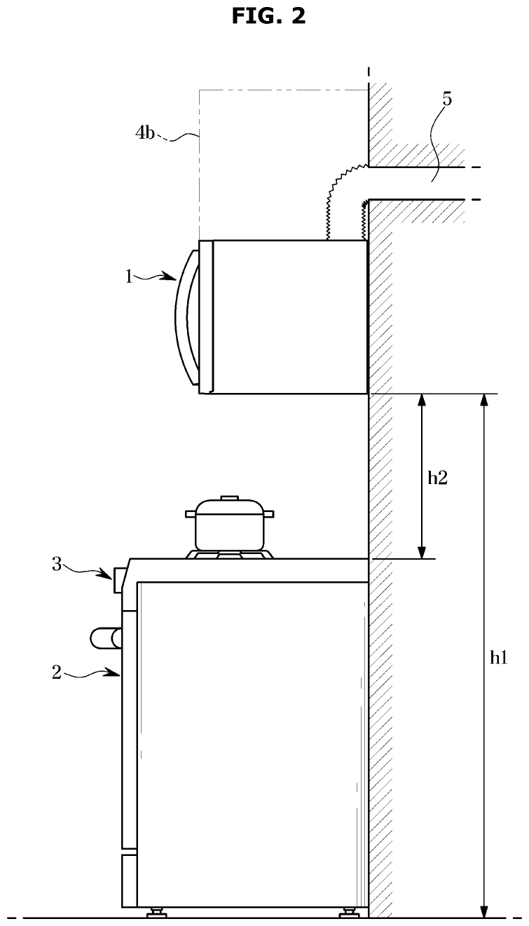

FIG. 1 is a perspective view of an installed cooking apparatus according to one embodiment of the present disclosure. FIG. 2 is a side view illustrating an installed cooking apparatus according to one embodiment of the present disclosure.

Referring to FIGS. 1 and 2, according to one embodiment of the present disclosure, first to third cooking apparatuses 1, 2 and 3 may be disposed indoors. For example, the first to the third cooking apparatus 1, 2, and 3 may be disposed in a kitchen. The first cooking apparatus 1 may be coupled to a storage cabinet 4. For example, the first cooking apparatus 1 may be disposed in an upper cabinet 4b.

The second cooking apparatus 2 and the third cooking apparatus 3 may be spaced apart from the first cooking apparatus 1 by a predetermined distance h2, and may be installed below the first cooking apparatus 1. For example, the second cooking apparatus 2 and the third cooking apparatus 3 may be arranged in a lower cabinet 4a.

The first cooking apparatus 1 may be disposed above the second cooking apparatus 2 and the third cooking apparatus 3. The first cooking apparatus 1 may discharge exhaust gas, smoke, or food odors generated by the second cooking apparatus 2 and the third cooking apparatus 3 to the outdoors. For example, the first cooking apparatus 1 may perform a hood function. However, the function of the first cooking apparatus 1 is not limited to this, and it is possible to cook food at a high frequency through a magnetron or to cook food through a heater. The first cooking apparatus 1 may be connected at the top with an exhaust passage 5 to discharge air, gas, or smoke to the outside.

The first cooking apparatus 1 may be installed at a position at a predetermined height h1 from a floor surface. In this case, the first cooking apparatus 1 may be installed at a height h1 suitable for the eye level or at a height of the user so that the user may easily operate the first cooking apparatus 1. For example, if the first cooking apparatus 1 is a microwave oven, the first cooking apparatus 1 may be an over-the-range (OTR) with a hood.

Although an example in which the first to third cooking apparatuses 1 2, and 3 are installed indoors has been described, the installation method of the first to third cooking apparatuses 1, 2 and 3 is not limited thereto and may be installed in various ways depending on the size or characteristics of the place to be installed, the intended use of installation, etc.

Hereinafter, the first cooking apparatus 1 will be described in more detail. The first cooking apparatus 1 will be referred to as a cooking apparatus.

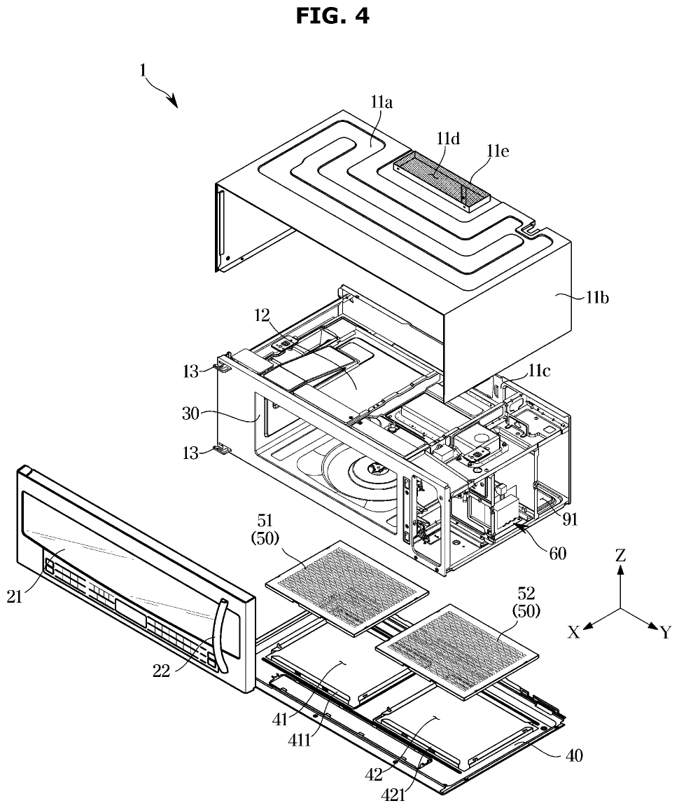

FIG. 3 is a perspective view of the cooking apparatus according to one embodiment of the present disclosure. FIG. 4 is an exploded perspective view of the cooking apparatus shown in FIG. 3.

Referring to FIGS. 3 and 4, a cooking apparatus according to one embodiment of the present disclosure may include a main body and a door.

The main body 10 may include an outer case 12 and an inner case 11.

The door 20 may be provided at a front of the main body 10. The door 20 may be rotatably arranged on the main body 10 to allow opening and closing of a cooking chamber 30. For example, the door 20 may be coupled to the main body 10 by a hinge 13.

However, the manner in which the main body 10 and the door 20 are coupled is not limited to the above examples. The door 20 may be provided in a shape corresponding to the front of the main body 10.

The door 20 may include a see-through portion 21 and a handle 22.

The see-through portion 21 may be arranged to allow a user to view a cooking state of food disposed within the cooking chamber 30 from outside the cooking apparatus 1.

The handle 22 may be arranged on an outer surface of the door 20 to be gripped by a user to open and close the door 20.

The outer case 12 may be arranged to receive the inner case 11 and the electronical components.

The outer case 12 may form the exterior of the main body 10. For example, the outer case 12 may cover the top, rear, and left and right sides of the inner case 11 and the electrical components.

The outer case 12 may include an upper surface 11a, a pair of side surfaces 11b, and a rear surface 11c. The outer case 12 may include an outlet 11d provided on the upper surface 11a.

The outlet 11d may be arranged for air discharged from the fan unit 100 described hereinafter to be discharged to the outside. The outlet 11d may be provided at the rear of the upper surface 11a of the outer case 12. However, the location of the outlet 11d is not limited thereto.

Further, the outer case 12 may include a discharge duct 11e in connection with the exhaust passage 5.

The discharge duct 11e may be formed in communication with the outlet 11d such that air discharged from the outlet 11d flows to the outside of the cooking apparatus 1.

The outer case 12 may include a lower surface 40. The lower surface 40 of the outer case 12 may form a bottom surface of the cooking apparatus 1. The lower surface 40 of the outer case 12 may form a lower exterior of the cooking apparatus 1.

The lower surface 40 of the outer case 12 may be detachably arranged with respect to a pair of side surface 11b and rear surface 11c. The lower surface 40 of the outer case 12 may be provided as a plate. However, without limitation, the lower surface 40 of the outer case 12 may be integrally formed with the pair of side surfaces 11b and the rear surface 11c.

A first inlet hole 41 and a second inlet hole 42 may be formed on the lower surface 40 of the outer case 12. The first inlet hole 41 and the second inlet hole 42 may be spaced apart along a left and right direction (Y direction) of the cooking apparatus 1. The first inlet hole 41 may be formed on one side of the cooking apparatus 1, and the second inlet hole 42 may be formed on the other side opposite the one side of the cooking apparatus 1.

The lower surface 40 of the outer case 12 may be disposed in a lower portion of the main body 10 to suction smoke, oil vapor, or air emitted from the second and third cooking apparatus 1, 2, 3 as shown in FIGS. 1 and 2. In detail, contaminated air from the lower side of the cooking apparatus 1 may be suctioned into the cooking apparatus 1 through the first inlet hole 41 and the second inlet hole 42 formed on the lower surface 40 of the outer case 12.

The cooking apparatus 1 may include a filter 50 mounted on the lower surface 40 of the outer case 12.

The filter 50 may be detachably coupled to the lower surface 40 of the outer case 12. The filter 50 may filter out debris contained in the smoke emitted from the second and third cooking apparatus 2 and 3.

The filter 50 may include a first filter 51 and a second filter 52.

The first filter 51 may be mounted on a first support portion 411 provided on the rim of the first inlet hole 41. The first support portion 411 may extend upwardly from the lower surface 40 of the outer case 12. Accordingly, the first filter 51 may be mounted on the first support portion 411 and secured to an upper portion of the first inlet hole 41.

The second filter 52 may be mounted on a second support portion 421 arranged on the rim of the second inlet hole 42. The second support portion 421 may extend upwardly from the lower surface 40 of the outer case 12. Accordingly, the second filter 52 may be mounted on the second support portion 421 and secured to an upper portion of the second inlet hole 42.

The first filter 51 may be disposed on a side adjacent to the fan unit 100 described later. The second filter 52 may be disposed farther away from the fan unit 100 compared to the first filter 51.

The cooking apparatus 1 may include a cooking chamber 30. The cooking chamber 30 may be formed within the inner case 11 for cooking food.

The cooking apparatus 1 may include a magnetron (not shown) that generates a high frequency and a heater (not shown) that generates heat. Further, the cooking apparatus 1 may include a holder (not shown) disposed at a lower portion of the cooking chamber 30 such that food is disposed in the cooking chamber 30.

The cooking apparatus 1 may include electrical components disposed between the inner case 11 and the outer case 12. The electrical components may include a control unit 60 and a power board 80. The control unit 60 and the power board 80 may be disposed on one side of the cooking chamber 30.

For example, the control unit 60 may be disposed on an outer side of the inner case 11 and an inner side of the outer case 12. The control unit 60 may be arranged to control the intensity or strength of the magnetron and/or heater.

The control unit 60 may be arranged to regulate a rotational speed of the fan unit 100.

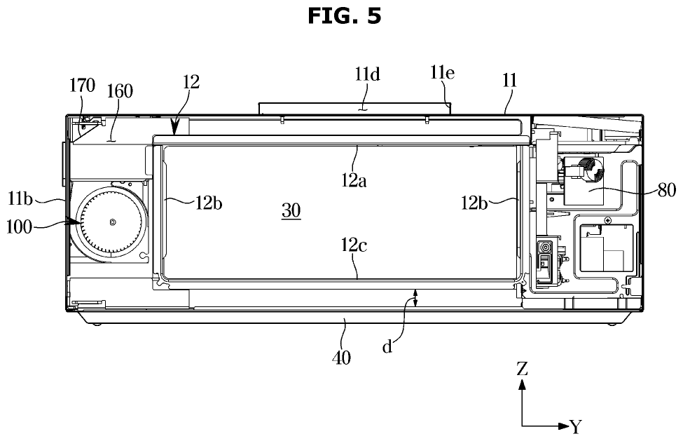

FIG. 5 is a front view of the cooking apparatus shown in FIG. 3.

Referring to FIG. 5, the inner case 11 according to one embodiment of the present disclosure may include an upper wall 12a, a pair of sidewalls 12b, and a lower wall 12c. A cooking chamber 30 may be formed by the inner case 11.

On one side of the inner case 11, a fan unit 100 may be disposed. For example, the fan unit 100 may be disposed on the left side of the inner case 11 when the cooking apparatus 1 is viewed from the front.

On the other side of the inner case 11, electrical components including the power board 80 may be disposed. For example, the electrical components may be disposed on the right side of the inner case 11 when the cooking apparatus 1 is viewed from the front.

The lower surface 40 of the outer case 12 and the inner case 11 may be arranged to be spaced apart by a certain distance d. By doing so, sufficient space may be formed for oil vapor suctioned into the interior of the cooking apparatus 1 through the first inlet hole 41 and the second inlet hole 42 formed on the lower surface 40 of the outer case 12 to flow to the fan unit 100.

On the inside of the outer case 12, a discharge flow path 160 may be formed. A guide panel 170 may be disposed on the upper end of one side of the discharge flow path 160. As will be described later, air that has been suctioned through the lower surface 40 of the outer case 12, filtered, and passed through the fan unit 100 may pass through the discharge flow path 160 and be discharged to the outside through the outlet 11d formed on the upper surface 11a of the outer case 12. Further details in this regard will be described below.

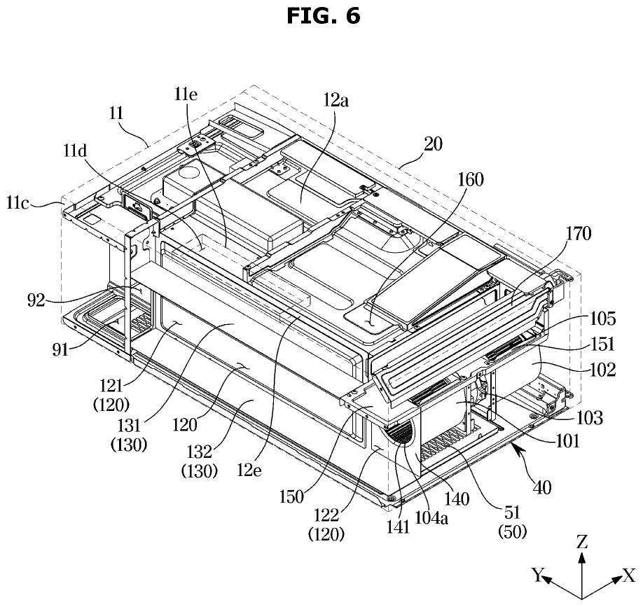

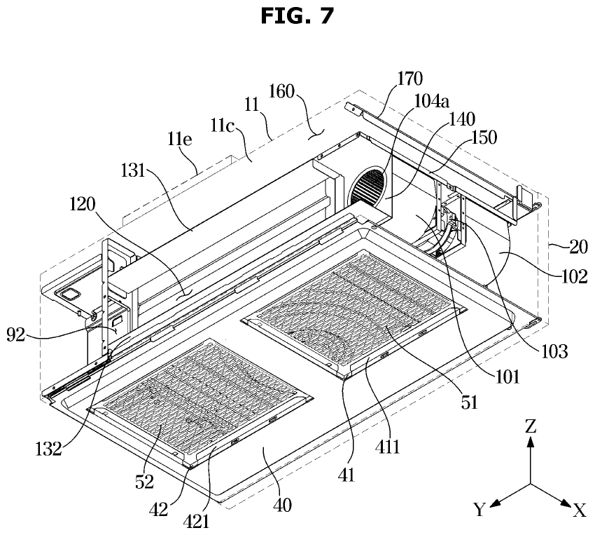

FIG. 6 is a perspective view of the cooking apparatus shown in FIG. 3 from a rear upper side. FIG. 7 is a perspective view of the cooking apparatus shown in FIG. 3 from a rear bottom view.

Referring to FIGS. 6 and 7, the cooking apparatus 1 according to one embodiment of the present disclosure may include a fan unit 100.

The fan unit 100 may be disposed between the inner case 11 and the outer case 12. The fan unit 100 may be disposed on one side of the inner case 11. For example, the fan unit 100 may be disposed on the left side of the inner case 11 when the cooking apparatus 1 is viewed from the front, and may suction air into the first inlet hole 41. The air suctioned into the first inlet hole 41 may be filtered by the first filter 51 and flow toward the fan unit 100.

The fan unit 100 may include fans 101 and 102 and a motor 103. The fans may be provided in plural. The plurality of fans may include a first fan 101 and a second fan 102. However, the number of fans is not limited, and the fans may be provided in a single unit or in three or more units thereof.

The cooking apparatus 1 may include a rear flow path 120. The rear flow path 120 may be arranged so that air introduced into the interior through the second inlet hole 42 and the second filter 52 is directed to the fan unit 100.

The inner case 11 may include a first vent hole 91 and a second vent hole 92.

The first vent hole 91 may be formed in a lower portion of the inner case 11. The first vent hole 91 may be arranged to allow air introduced into the interior of the outer case 12 through the second inlet hole 42 to flow. The first vent hole 91 may be formed by incising a rear lower portion of the inner case 11 to be adjacent to the rear flow path 120.

The second vent hole 92 may be formed in a rear portion of the inner case 11. The second vent hole 92 may be arranged to allow air flowing into the first vent hole 91 to flow into the rear flow path 120. The second vent hole 92 may be in communication with the rear flow path 120. The second vent hole 92 may be formed by an incision in one sidewall 12b of the inner case 11.

One end of the rear flow path 120 may be provided as an inlet 121. The inlet 121 may be in communication with the second vent hole 92 of the inner case 11.

The other end of the rear flow path 120 may be provided as an outlet 122. The outlet 122 may be in communication with the inlet 121 of the first fan 101.

Thus, air introduced into the second inlet hole 42 and the second filter 52 formed at a location not adjacent to the fan unit 100 may be guided to the fan unit 100 via the rear flow path 120.

The height of the rear flow path 120 may be provided to be equal to the vertical length of the fan unit 100. However, the height of the rear flow path 120 is not limited thereto and may be provided to be longer than the vertical length of the fan unit 100.

The cooking apparatus 1 may include a flow path forming panel 130.

The flow path forming panel 130 may be arranged to partition the rear flow path 120 in an upper to lower direction. The flow path forming panel 130 may be arranged to be in contact with the rear wall 12e of the inner case 11 to form the rear flow path 120. The flow path forming panel 130 may be coupled to the rear wall 12e of the inner case 11 in a variety of ways.

The flow path forming panel 130 may be provided in a plurality. The plurality of flow path forming panels 130 may be spaced apart from each other along an upper to lower direction.

The plurality of flow path forming panels 130 may include a first flow path forming panel 131 and a second flow path forming panel 132.

The first flow path forming panel 131 may be disposed on the upper side of the second flow path forming panel 132. The rear flow path 120 may be formed between the first flow path forming panel 131 and the second flow path forming panel 132. Accordingly, a separation distance in the upper to lower direction of the first flow path forming panel 131 and the second flow path forming panel 132 may be arranged to be equal to a vertical length of the fan unit 100. However, without limitation, the separation distance in the upper to lower direction of the first flow path forming panel 131 and the second flow path forming panel 132 may be larger than the vertical length of the fan unit 100.

The rear flow path 120 may be formed between the rear surface 11c of the outer case 12 and the rear wall 12e of the inner case 11, and may be formed between the first flow path forming panel 131 and the second flow path forming panel 132, so as to be partitioned in the front-to rear direction and partitioned in the upper to lower direction. That is, the rear flow path 120 may be arranged so that only the inlet 121 and the outlet 122 are in communication with the outside.

A combining panel 140 may be disposed on one side of the rear wall 12e of the inner case 11. For example, the combining panel 140 may be disposed on the left side of the rear wall 12e of the inner case 11 when the cooking apparatus 1 is viewed from the front.

The combining panel 140 may be combined with the fan unit 100. The combining panel 140 may include a hole 141 to which the fan unit 100 is coupled. The first fan 101 of the fan unit 100 may be inserted into the hole 141 of the combining panel 140 to be coupled. The holes 141 may be formed to correspond to the size of the fan unit 100.

The combining panel 140 may be disposed to prevent air from flowing anywhere except the inlet 121 of the fan unit 100. In other words, the combining panel 140 may prevent air entering the fan unit 100 from escaping in other directions. With the combining panel 140, air from the lower side of the cooking apparatus 1 may be more efficiently suctioned into the fan unit 100 and discharged to the outside. More specifically, the combining panel 140 may divide the flow path so that air entering the rear flow path 120 through the second inlet hole 42 and air entering the fan unit 100 through the first inlet hole 41 do not mix. More details regarding this will be described later.

The discharge panel 150 may be disposed on the outer side of the inner case 11. The discharge panel 150 may be disposed between the inner case 11 and the outer case 12. The discharge panel 150 may be disposed on an upper side of the fan unit 100. The discharge panel 150 may include a discharge port 151 arranged for air discharged from the fan unit 100 to flow to the guide panel 170. The discharge port 151 may be formed to correspond to an outlet 105 of the fan unit 100.

The discharge flow path 160 may be arranged between the inner case 11 and the outer case 12 to allow air from the outlet 105 of the fan unit 100 and the discharge port 151 to flow. Further, the discharge flow path 160 may be arranged as a path for air from the outlet 105 of the fan unit 100 and the discharge port 151 to be discharged into the discharge duct 11e.

The guide panel 170 may be arranged to guide the air discharged from the outlet 105 of the fan unit 100 toward the discharge duct. The guide panel 170 may be disposed on the discharge flow path 160.

The guide panel 170 may be disposed on the upper side of the discharge panel 150. The guide panel 170 may be disposed with an upward slope relative to the discharge panel 150. The guide panel 170 may be arranged to slope upwardly from an outer side to an inner side. However, the shape and position of the guide panel 170 is not limited.

The first inlet hole 41 and the first filter 51 may be formed at a location adjacent to the fan unit 100. Accordingly, air passing through the first inlet hole 41 and the first filter 51 may flow toward the fan unit 100. More specifically, air introduced into the interior of the outer case 12 through the first inlet hole 41 formed on the lower surface 40 of the outer case 12 may flow toward the fan unit 100 through a space between the outer case 12 and the inner case 11.

The second inlet hole 42 and the second filter 52 may be formed at a location distant from the fan unit 100 relative to the first inlet hole 41 and the second filter 52. The second inlet hole 42 and the second filter 52 may be formed adjacent to the first vent hole 91.

Air introduced into the interior of the outer case 12 via the second inlet hole 42 and the second filter 52 may flow toward the first vent hole 91 and flow toward the fan unit 100 via the rear flow path 120.

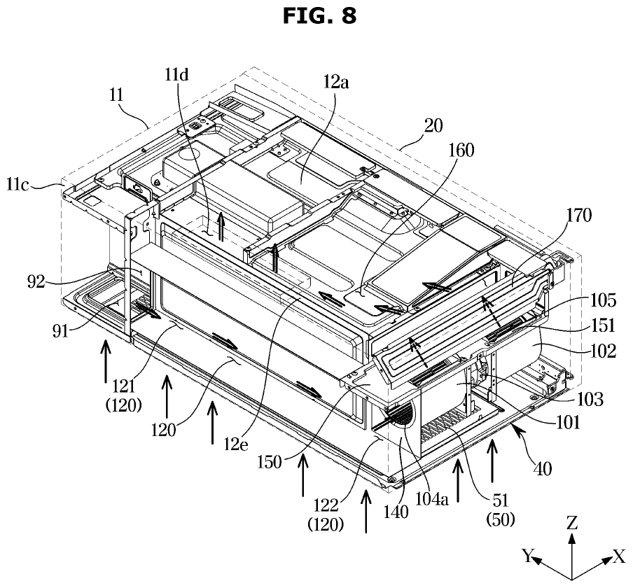

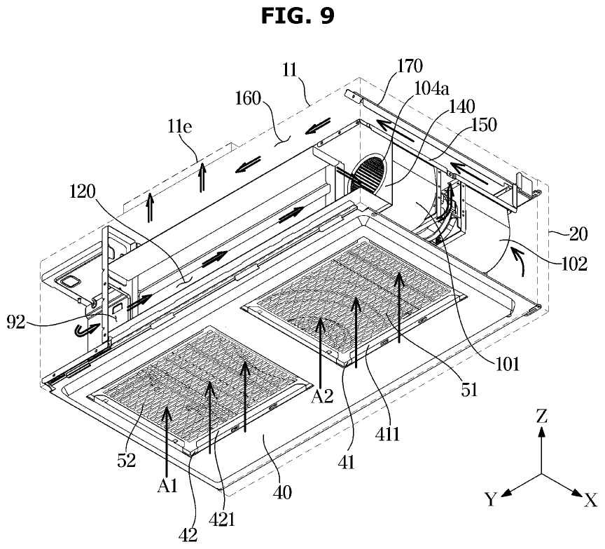

FIG. 8 is a diagram illustrating the flow of air in the cooking apparatus shown in FIG. 6. FIG. 9 is a diagram illustrating the flow of air in the cooking apparatus shown in FIG. 7.

Hereinafter, the flow of smoke and/or air from the second cooking apparatus 2 and the third cooking apparatus 3 will be described.

Referring to FIGS. 8 and 9, smoke generated by the second cooking apparatus 2 and the third cooking apparatus 3 may be suctioned into the lower surface 40 of the outer case 12 of the first cooking apparatus 1. More specifically, the air may pass through the first inlet hole 41 formed in the lower surface 40 of the outer case 12 and the first filter 51 arranged to cover the first inlet hole 41, and may pass through the second inlet hole 42 formed in the lower surface 40 of the outer case 12 and the second filter 52 arranged to cover the second inlet hole 42. Foreign matter contained in the oil vapor and smoke may be filtered out by the first filter 51 and the second filter 52.

Air that has passed through the first inlet hole 41 and the first filter 51 may flow into the adjacent fan unit 100. Air entering the fan unit 100 may flow through the discharge port 151 of the discharge panel 150 and into the discharge flow path 160.

The air flowing into the discharge flow path 160 may be guided upward by the guide panel 170 to flow into the upper side of the inner case 11. The air flowing to the upper side of the inner case 11 may flow out to the discharge duct 11e through the outlet 11d formed on the upper surface 11a of the outer case 12.

Air that has passed through the second inlet hole 42 and the second filter 52 may flow into the adjacent first vent hole 91. After passing through the first vent hole 91, the air may flow into the second vent hole 92.

The air may flow through the second vent hole 92 into the rear flow path 120 formed by the flow path forming panel 130. The outlet 122 side of the rear flow path 120 is connected to the fan unit 100, so that air in the rear flow path 120 may flow from the inlet 121 to the outlet 122 side of the rear flow path 120 by the suction force of the fan unit 100.

The air flowing to the outlet 122 side of the rear flow path 120 may pass through the hole 141 of the combining panel 140 and be suctioned into the fan unit 100.

The air may then flow to the discharge flow path 160 through the discharge port 151 of the discharge panel 150, and may be guided by the guide panel 170 to flow toward the discharge duct 11e.

Thus, smoke or air generated by the second cooking apparatus 2 and the third cooking apparatus 3 may be directly suctioned into the fan unit 100, or may be diverted to the rear flow path 120 and suctioned into the fan unit 100.

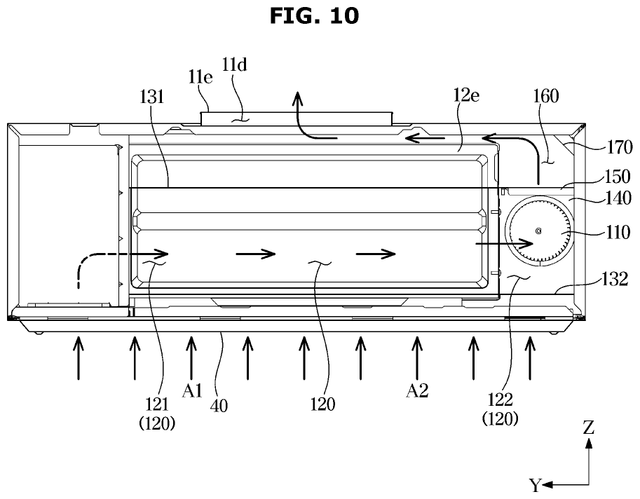

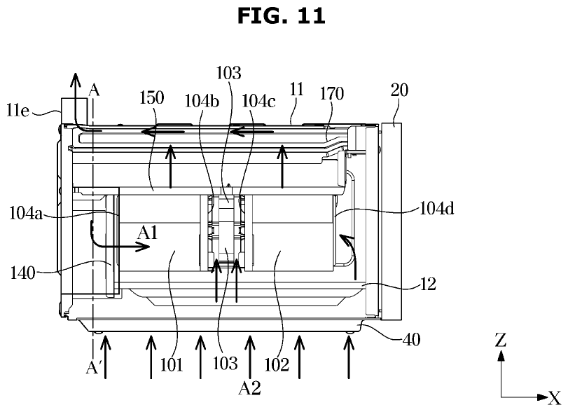

FIG. 10 is a rear view of the air flow of the cooking apparatus according to one embodiment of the present disclosure. FIG. 11 is a drawing illustrating the air flow of the cooking apparatus according to one embodiment of the present disclosure from the side where the fan is located.

Referring to FIG. 10, air A1 introduced into a second inlet 104b and a second filter 52 of the cooking apparatus 1 according to one embodiment of the present disclosure may flow into the rear flow path 120 after passing through the first vent hole 91 and the second vent hole 92 shown in FIG. 8. The air flowed in the rear flow path 120 may flow to the fan unit 100, which is in communication with the combining panel 140. The air discharged from the fan unit 100 to the top via the discharge panel 150 may be guided by the guide panel 170 and flow to the outlet 11d via the discharge flow path 160. The air flowed to the outlet 11d may be discharged by the discharge duct 11e to the outside of the cooking apparatus 1 through the exhaust passage 5 as shown in FIG. 2.

Referring to FIG. 11, air A2 introduced into a first inlet 104a and a first filter 51 of the cooking apparatus 1 according to one embodiment of the present disclosure may be directly suctioned into the fan unit 100. In other words, the air A2 introduced into the first inlet 104a and the first filter 51 may be directly suctioned into the adjacent fan unit 100 without being diverted to the rear flow path 120.

The fan unit 100 may include a plurality of inlets 121.

A first fan 101 may include a first inlet 104a and a second inlet 104b. The second fan 102 may include a third inlet 104c and a fourth inlet 104d.

The number of inlets 121 may be formed to correspond to the number of fans 101, 102, i.e., two inlets 121 may be formed for one fan.

The first inlet 104a is connected with the outlet 122 of the rear flow path 120, so that the air A1 flowed in the rear flow path 120 may flow into the fan unit 100.

The second inlet 104b, the third inlet 104c, and the fourth inlet 104d are connected to the space between the inner case 11 and the outer case 12, so that air A2 that has passed through the first inlet hole 41 of the outer case 12 and the first filter 51 may flow into the fan unit 100.

The following is an experimental table showing the air volume for each intake flow path according to presence or absence of the rear flow path 120.

TABLE 1

| | Absence of the rear | Presence of the rear |
|---|---|---|
| Air volume (CCM) | flow path 120 | flow path 120 |
| First intake flow path A1 | 0.60 | 1.90 |
| Second intake flow path A2 | 4.84 | 3.63 |

As may be seen from the above table, the air volume of the second intake flow path A2, through which air passing through the first inlet hole 41 and the first filter 51 flows to the fan unit 100, is reduced compared to the case without the rear flow path 120. However, the air volume of the first inlet flow path A1 in which air passing through the second inlet hole 42 and the second filter 52 flows to the fan unit 100 via the rear flow path 120 is increased compared to the case without the rear flow path 120.

Therefore, by forming the rear flow path 120 in the cooking apparatus 1 according to one embodiment of the present disclosure, air passing through the first inlet hole 41 and the second inlet hole 42 may be suctioned into the cooking apparatus 1 relatively uniformly even with one fan unit 100.

In other words, overall cost reduction and weight reduction may be realized by placing the fan unit 100 on only one side of the cooking apparatus 1. At the same time, it is possible to realize a cooking apparatus 1 having an improved structure so that the air suctioned into the interior may flow in a relatively balanced manner.

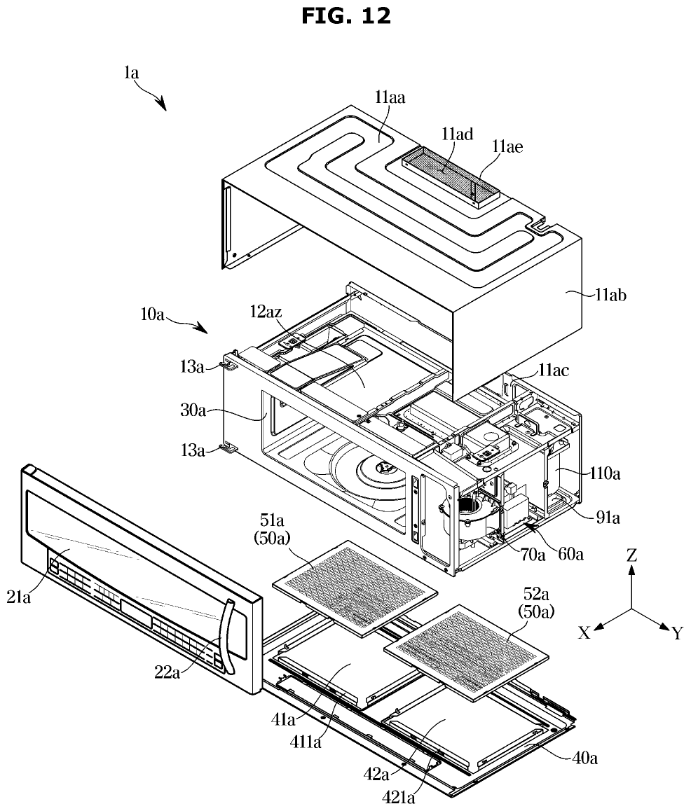

FIG. 12 is an exploded perspective view of a cooking apparatus according to another embodiment of the present disclosure.

Referring to FIG. 12, a cooking apparatus 1a according to another embodiment of the present disclosure may include a main body 10a and a door 20a.

The main body 10a may include an outer case 12az and an inner case 11az.

The door 20a may be provided at a front of the main body 10a. The door 20a may be rotatably arranged on the main body 10a to allow opening and closing of a cooking chamber 30a. For example, the door 20a may be coupled to the main body 10a by the hinge 13a.

However, the manner in which the main body 10a and the door 20a are coupled is not limited to the above examples. The door 20a may be provided in a shape corresponding to the front of the body 10a.

The door 20a may include a through portion 21a and a handle 22a. The through portion 21a may be arranged to allow a user to view, from outside the cooking apparatus 1a, the state in which food disposed within the cooking chamber 30a is being cooked.

The handle 22a may be grippably arranged on an outer surface of the door 20a to allow a user to open and close the door 20a.

The outer case 12az may be arranged to receive the inner case 11az and electrical components.

The outer case 12az may form the exterior of the main body 10a. For example, the outer case 12az may cover the top, rear, and left and right sides of the inner case 11az and the electronics.

The outer case 12az may include a upper surface 11aa, a pair of side surfaces 11ab, and a rear surface 11ac. the outer case 12az may include an outlet 11ad provided on the upper surface 11aa.

The outlet 11ad may be arranged for air discharged from a fan unit 100a described below to be discharged to the outside. The outlet 11ad may be provided at the rear of the upper surface 11aa of the outer case 12az. However, the location of the outlet 11ad is not limited thereto.

Further, the outer case 12az may include a discharge duct 11ae that is connected to the exhaust passage 5.

The discharge duct 11ae may be formed in communication with the outlet 11ad such that air discharged from the outlet 11ad flows to the outside of the cooking apparatus 1a.

The outer case 12az may include a lower surface 40a. The lower surface 40a of the outer case 12az may form a bottom surface of the cooking apparatus 1a. The lower surface 40a of the outer case 12az may form a lower exterior of the cooking apparatus 1a.

The lower surface 40a of the outer case 12az may be detachably arranged with respect to the pair of side surfaces 11ab and the rear surface 11ac. The lower surface 40a of the outer case 12az may be provided as a plate. However, without limitation, the lower surface 40a of the outer case 12az may be integrally formed with the pair of the side surfaces 11ab and the rear surface 11ac.

A first inlet hole 41a and a second inlet hole 42a may be formed on the lower surface 40a of the outer case 12az. The first inlet hole 41a and the second inlet hole 42a may be spaced apart along a left and right direction (Y direction) of the cooking apparatus 1a. The first inlet hole 41a may be formed on a first side of the cooking apparatus 1a, and the second inlet hole 42a may be formed on a second side opposite to the first side of the cooking apparatus 1a.

The lower surface 40a of the outer case 12az may be disposed at a lower side t of the main body 10a to suction smoke, oil vapor, or air emitted from the second and third cooking apparatus 1a, 2, 3 as shown in FIGS. 1 and 2. In detail, contaminated air from the lower side of the cooking apparatus 1a may be suctioned into the cooking apparatus 1a through the first inlet hole 41a and the second inlet hole 42a formed on the lower surface 40a of the outer case 12az.

The cooking apparatus 1a may include a filter 50a that is mounted on the lower surface 40a of the outer case 12az.

The filter 50a may be detachably coupled to the lower surface 40a of the outer case 12az. The filter 50a may filter out debris contained in the smoke emitted from the second and third cooking apparatus 2, 3.

The filter 50a may include a first filter 51a and a second filter 52a.

The first filter 51a may be mounted on a first support portion 411a that is arranged on the rim of the first inlet hole 41a. The first support portion 411a may extend upwardly from the lower surface 40a of the outer case 12az. Accordingly, the first filter 51a may be mounted on the first support portion 411a and fixed to an upper portion of the first inlet hole 41a.

The second filter 52a may be mounted on the second support portion 421a, which is arranged on the rim of the second inlet hole 42a. The second support portion 421a may extend upwardly from the lower surface 40a of the outer case 12az. Accordingly, the second filter 52a may be mounted on a second support portion 421a and fixed to an upper portion of the second inlet hole 42a.

The first filter 51a may be disposed on a side adjacent to the fan unit 100a described below. The second filter 52a may be disposed distant from the fan unit 100a compared to the first filter 51a.

The cooking apparatus 1a may include a cooking chamber 30a. The cooking chamber 30a may be formed within the inner case 11az for cooking food.

The cooking apparatus 1a may include a magnetron (not shown) that generates a high frequency and a heater (not shown) that generates heat. Further, the cooking apparatus 1a may include a holding member (not shown) disposed in a lower portion of the cooking chamber so that food is disposed in the cooking chamber 30a.

The cooking apparatus 1a may include electrical components disposed between the inner case 11az and the outer case 12az. The electrical components may include a control unit and a power board 80a. The control unit 60a and the power board 80a may be disposed on one side of the cooking chamber 30a.

For example, the control unit 60a may be disposed on an outer side of the inner case 11az and an inner side of the outer case 12az. The control unit 60a may be arranged to control the intensity or strength of the magnetron and/or heater.

The control unit 60a may be arranged to regulate the rotational speed of the fan unit 100a.

Furthermore, the cooking apparatus 1a according to another embodiment of the present disclosure may include a heat dissipation fan 70a and a sub-fan unit 110a, unlike the cooking apparatus 1 according to the first embodiment of the present disclosure.

The heat dissipation fan 70a may be disposed on one side of the cooking chamber 30a together with the control unit 60a. The control unit 60a may adjust a rotational speed of the heat dissipation fan 70a. The heat dissipation fan 70a may be arranged to dissipate heat generated by the control unit 60a or the power board 80a. The heat dissipation fan 70a may be arranged to cool the control unit 60a or the power board 80a. By doing so, the control unit 60a or the power board 80a may be prevented from being overheated and failing.

The sub fan unit 110a of the cooking apparatus 1a according to another embodiment of the present disclosure may be disposed between a first vent hole 91a and a second vent hole 92a to allow more air to be suctioned into a rear flow path 120a. More details regarding this will be described later.

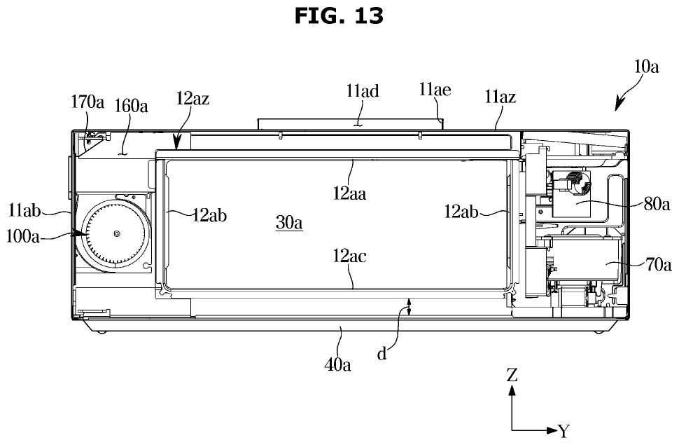

FIG. 13 is a front view of the cooking apparatus shown in FIG. 12.

Referring to FIG. 13, the inner case 11az according to another embodiment of the present disclosure may include an upper wall 12aa, a pair of sidewalls 12ab, and a lower wall 12ac. The cooking chamber 30a may be formed by the inner case 11az.

The fan unit 100a may be disposed on one side of the inner case 11az. For example, the fan unit 100a may be disposed on the left side of the inner case 11az when the cooking apparatus 1a is viewed from the front.

On the other side of the inner case 11az, electrical components including the power board 80a may be disposed. For example, the electrical components may be disposed on the right side of the inner case 11az when the cooking apparatus 1a is viewed from the front.

The lower surface 40a of the outer case 12az and the inner case 11az may be arranged to be spaced apart by a certain distance d. Thereby, sufficient space may be formed for oil vapor suctioned into the interior of the cooking apparatus 1a through the first inlet hole 41a and the second inlet hole 42a formed in the lower surface 40a of the outer case 12az to flow to the fan unit 100a.

A discharge flow path 160a may be formed on the inside of the outer case 12az. A guide panel 170a may be disposed on the upper end of one side of the discharge flow path 160a. As will be described below, air that has been suctioned in through the lower surface 40a of the outer case 12az, filtered, and passed through the fan unit 100a may pass through the discharge flow path 160a and be discharged to the outside through the outlet 11ad formed on the upper surface 11aa of the outer case 12az. More details regarding this will be described later.

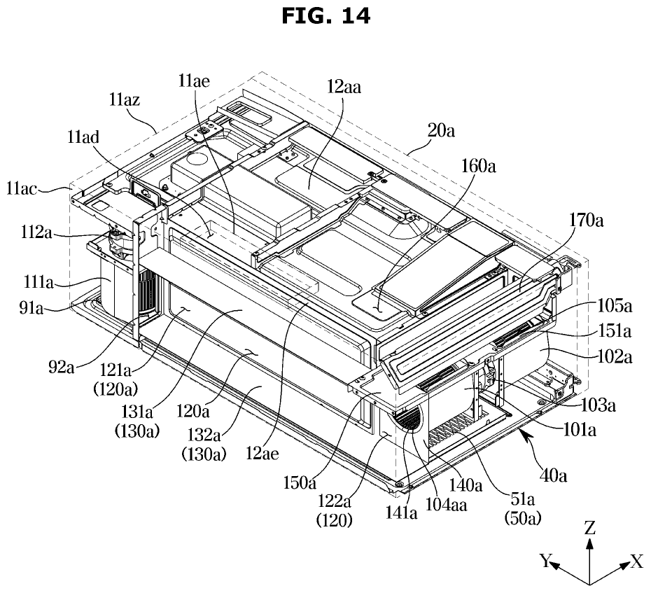

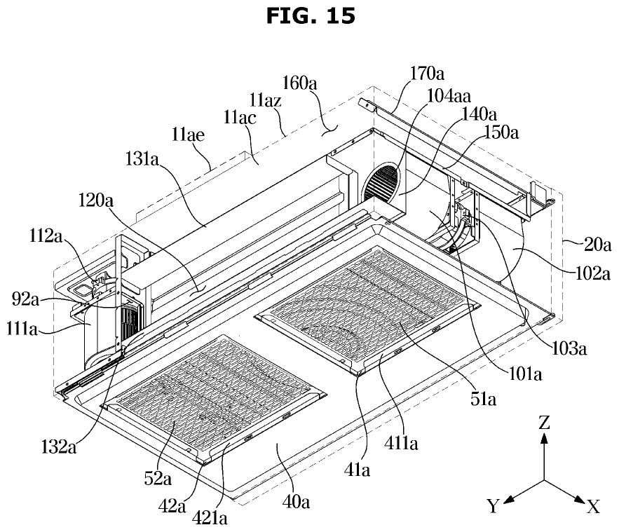

FIG. 14 is a perspective view of the cooking apparatus shown in FIG. 12 from a rear upper side. FIG. 15 is a perspective view of the cooking apparatus shown in FIG. 12 from a rear bottom view.

Referring to FIGS. 14 and 15, the cooking apparatus 1a according to another embodiment of the present disclosure may include the fan unit 100a and the sub fan unit 110a.

The fan unit 100a may be disposed between the inner case 11az and the outer case 12az. The fan unit 100a may be disposed on one side of the inner case 11az. For example, the fan unit 100a may be disposed on the left side of the inner case 11az when the cooking apparatus 1a is viewed from the front, and may draw air into the first inlet hole 41a. The air suctioned into the first inlet hole 41a may be filtered by the first filter 51a and flowed toward the fan unit 100a.

The fan unit 100a may include a fans 101a and 102a and a motor 103a. The fans may be provided in a plurality. The plurality of fans may include a first fan 101a and a second fan 102a. However, the number of fans is not limited to this, and the fans may be arranged in a single unit or in three or more units thereof.

The cooking apparatus 1a may include a rear flow path 120a. The rear flow path 120a may be arranged so that air introduced into the interior through the second inlet hole 42a and the second filter 52a is directed to the fan unit 100a.

The inner case 11az may include a first vent hole 91a and a second vent hole 92a.

The first vent hole 91a may be formed in a lower portion of the inner case 11az. The first vent hole 91a may be arranged to allow air introduced into the interior of the outer case 12az through the second inlet hole 42a to flow. The first vent hole 91a may be formed by incising a rear lower portion of the inner case 11az to be adjacent to the rear flow path 120a.

The second vent hole 92a may be formed at the rear of the inner case 11az. The second vent hole 92a may be arranged so that air flowing into the first vent hole 91a flows into the rear flow path 120a. The second vent hole 92a may be in communication with the rear flow path 120a. The second vent hole 92a may be formed by an incision in one sidewall 12ab of the inner case 11az.

One end of the rear flow path 120a may be provided as an inlet 121a. The inlet 121a may be in communication with the second vent hole 92a of the inner case 11az.

The other end of the rear flow path 120a may be provided as an outlet 122a. The outlet 122a may be in communication with the inlet of the first fan 101a.

Accordingly, air introduced into the second inlet hole 42a and the second filter 52a formed at a location not adjacent to the fan unit may be guided through the sub fan unit 110a into the fan unit 100a. The sub fan unit 110a may include a sub fan 111a and a sub motor 112a connected to the sub fan 111a to drive the sub fan 111a.

The height of the rear flow path 120a may be provided to be the same as the vertical length of the fan unit 100a. However, the height of the rear flow path 120a is not limited thereto and may be provided to be longer than the vertical length of the fan unit 100a.

The cooking apparatus 1a may include a flow path forming panel 130a.

The flow path forming panel 130a may be arranged to partition the rear flow path 120a in an upper to lower direction. The flow path forming panel 130a may be arranged to be in contact with the rear wall 12ae of the inner case 11az to form the rear flow path 120a. The flow path forming panel 130a may be coupled to the rear wall 12ae of the inner case 11az in a variety of ways.

The flow path forming panel 130a may be provided in a plurality. The plurality of flow path forming panels 130a may be spaced apart from each other along an upper to lower direction.

The plurality of flow path forming panels 130a may include a first flow path forming panel 131a and a second flow path forming panel 132a.

The first flow path forming panel 131a may be disposed on the upper side of the second flow path forming panel 132a. The rear flow path 120a may be formed between the first flow path forming panel 131a and the second flow path forming panel 132a. Accordingly, a separation distance in the upper to lower directions of the first flow path forming panel 131a and the second flow path forming panel 132a may be arranged to be equal to a vertical length of the fan unit 100a. However, without being limited thereto, the spacing distances in the upper to lower direction of the first flow path forming panel 131a and the second flow path forming panel 132a may be larger than the vertical length of the fan unit 100a.

The rear flow path 120a may be formed between the rear surface 11ac of the outer case 12az and the rear wall 12ae of the inner case 11az, and may be formed between the first flow path forming panel 131a and the second flow path forming panel 132a, so as to be partitioned in the front to rear direction and partitioned in the upper to lower direction. In other words, the rear flow path 120a may be arranged so that only the inlet 121a and the outlet 122a are in communication with the outside.

A combining panel 140a may be disposed on one side of the rear wall 12ae of the inner case 11az. For example, the combining panel 140a may be disposed on the left side of the rear wall 12ae of the inner case 11az when the cooking apparatus 1a is viewed from the front.

The combining panel 140a may be combined with the fan unit 100a. The combining panel 140a may include a hole 141a in which the fan unit 100a is coupled. The first fan 101a of the fan unit 100a may be inserted into the hole 141a of the combining panel 140a to be combined. The holes 141a may be formed to correspond to the size of the fan unit 100a.

The combining panel 140a may be arranged to prevent air from flowing to any place other than the inlet of the fan unit 100a. In other words, the combining panel 140a may prevent air entering the fan unit 100a from escaping in the other direction. Due to such a combining panel 140a, air from the lower side of the cooking apparatus 1a may be more efficiently suctioned into the fan unit 100a and discharged to the outside. More specifically, the combining panel 140a may partition the flow path so that the air entering the rear flow path 120a through the second inlet hole 42a and the air entering the fan unit 100a through the first inlet hole 41a do not mix. Details regarding this will be described below.

The discharge panel 150a may be disposed on an outer side of the inner case 11az. The discharge panel 150a may be disposed between the inner case 11az and the outer case 12az. The discharge panel 150a may be disposed on an upper side of the fan unit 100a. The discharge panel 150a may include a discharge port 151a arranged for air discharged from the fan unit 100a to flow to the guide panel 170a. The discharge port 151a may be formed to correspond to an outlet 105a of the fan unit 100a.

The discharge flow path 160a may be arranged between the inner case 11az and the outer case 12az to allow air from the outlet 105a and the discharge port 151a of the fan unit 100a to flow. Further, the discharge flow path 160a may be arranged as a path for air flowed from the outlet 105a and the discharge port 151a of the fan unit 100a to be discharged into the discharge duct 11ae.

The guide panel 170a may be arranged to guide the air discharged from the outlet 105a of the fan unit 100a toward the discharge duct. The guide panel 170a may be disposed on the discharge flow path 160a.

The guide panel 170a may be disposed on the upper side of the discharge panel 150a. The guide panel 170a may be arranged to slope upwardly with respect to the discharge panel 150a. The guide panel 170a may be arranged to slope upwardly from an outer side to an inner side. However, the shape and position of the guide panel 170a is not limited thereto.

The first inlet hole 41a and the first filter 51a may be formed at a location adjacent to the fan unit 100a. Accordingly, air passing through the first inlet hole 41a and the first filter 51a may flow toward the fan unit 100a. More specifically, air that flows into the interior of the outer case 12az through the first inlet hole 41a formed on the lower surface 40a of the outer case 12az may flow toward the fan unit 100a through a space between the outer case 12az and the inner case 11az.

The second inlet hole 42a and the second filter 52a may be formed at a location distant from the fan unit 100a relative to the first inlet hole 41a and the second filter 52a. The second inlet hole 42a and the second filter 52a may be formed adjacent to the first vent hole 91a.

Air introduced into the interior of the outer case 12az through the second inlet hole 42a and the second filter 52a may be suctioned by the sub-fan unit 110a and flow toward the first vent hole 91a, and flow toward the fan unit 100a via the rear flow path 120a.

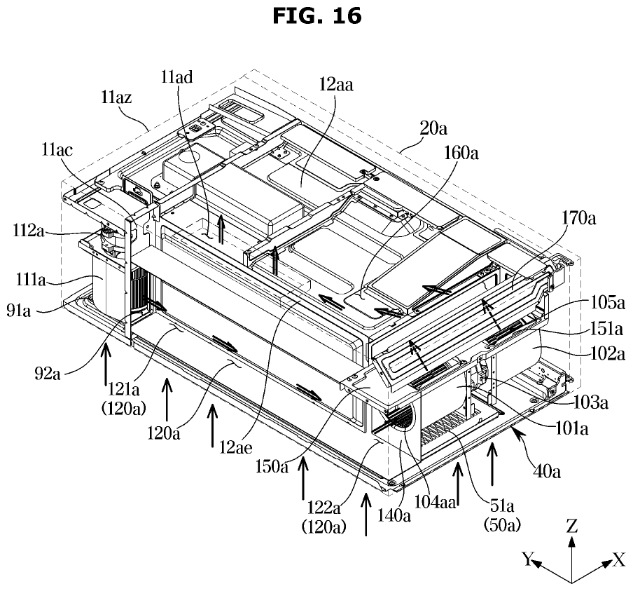

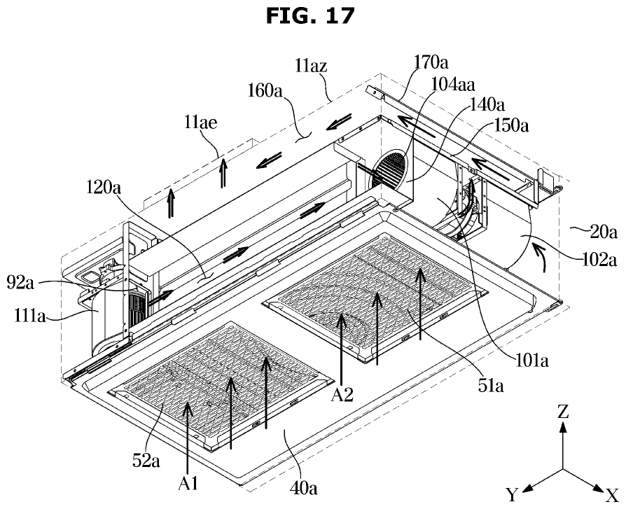

FIG. 16 is a diagram illustrating the flow of air in the cooking apparatus shown in FIG. 14. FIG. 17 is a diagram illustrating the flow of air in the cooking apparatus shown in FIG. 15.

Hereinafter, the flow of smoke and/or air from the second cooking apparatus 2 and the third cooking apparatus 3 will be described.

Referring to FIGS. 16 and 17, smoke generated by the second cooking apparatus 2 and the third cooking apparatus 3 may be suctioned into the lower surface 40a of the outer case 12az of the first cooking apparatus 1a. More specifically, the air may pass through the first inlet hole 41a formed in the lower surface 40a of the outer case 12az and the first filter 51a arranged to cover the first inlet hole 41a, and may pass through the second inlet hole 42a formed in the lower surface 40a of the outer case 12az and the second filter 52a arranged to cover the second inlet hole 42a. Foreign matter contained in oil vapor and smoke may be filtered out by the first filter 51a and the second filter 52a.

The air that has passed through the first inlet hole 41a and the first filter 51a may flow to the adjacent fan unit 100a. The air flowing into the fan unit 100a may flow through the discharge port 151a of the discharge panel 150a and into the discharge flow path 160a.

The air flowed into the discharge flow path 160a may be guided upward by the guide panel 170a to flow into the upper part of the inner case 11az. The air flowed to the upper part of the inner case 11az may flow out to the discharge duct 11ae through the outlet 11ad formed on the upper surface 11aa of the outer case 12az.

Air that has passed through the second inlet hole 42a and the second filter 52a may flow into the adjacent first vent hole 91a. The air passing through the first vent hole 91a may flow through the sub fan unit 110a and into the second vent hole 92a.

The air may flow through the second vent hole 92a to the rear flow path 120a formed by the flow path forming panel 130a. The outlet 122a side of the rear flow path 120a is connected to the fan unit 100a, so that the air in the rear flow path 120a may flow from the inlet 121a to the outlet 122a side of the rear flow path 120a by the suction force of the fan unit 100a.

The air flowed to the outlet 122a side of the rear flow path 120a may pass through the hole 141a of the combining panel 140a and be suctioned into the fan unit 100a.

The air may then flow to the discharge flow path 160a through the discharge port 151a of the discharge panel 150a, and may be guided by the guide panel 170a to flow toward the discharge duct 11ae.

Thus, smoke or air generated by the second cooking apparatus 2 and the third cooking apparatus 3 may be directly suctioned into the fan unit 100a, or may be diverted to the rear flow path 120a and suctioned into the fan unit 100a.

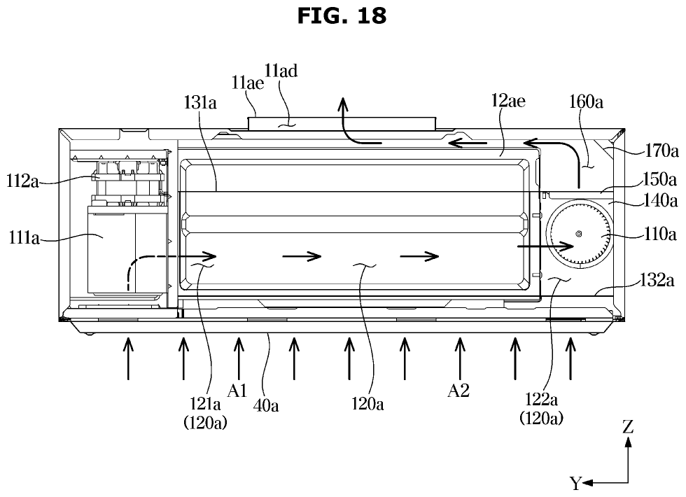

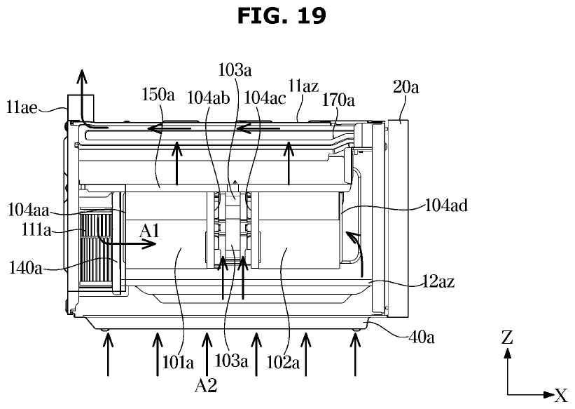

FIG. 18 is a rear view of air flow in a cooking apparatus according to another embodiment of the present disclosure. FIG. 19 is a drawing illustrating the air flow of the cooking apparatus according to another embodiment of the present disclosure from the side where the fan unit 100a is located.

Referring to FIG. 18, air A1 introduced into a second inlet 104ab and a second filter 52a of the cooking apparatus 1a according to another embodiment of the present disclosure may flow into the rear flow path 120a after passing through the first vent hole 91a, the sub fan unit 110a, and the second vent hole 92a shown in FIG. 16. The air flowed in the rear flow path 120a may flow to the fan unit 100a, which is in communication with the combining panel 140a. The air discharged upward from the fan unit 100a through the discharge panel 150a may be guided by the guide panel 170a and flow to the outlet 11ad via the discharge flow path 160a. The air flowing to the outlet 11ad may be discharged by the discharge duct 11ae to the outside of the cooking apparatus 1a through the exhaust passage 5 as shown in FIG. 2.

Referring to FIG. 19, air a2 introduced into a first inlet 104aa and a first filter 51a of the cooking apparatus 1a according to another embodiment of the present disclosure may be directly suctioned into the fan unit 100a. In other words, the air a2 introduced into the first inlet 104aa and the first filter 51a may be directly suctioned into the adjacent fan unit 100a without being diverted to the rear flow path 120a.

The fan unit 100a may include a plurality of inlets.

A first fan 101a may include a first inlet 104aa and a second inlet 104ab. The second fan 102a may include a third inlet 104ac and a fourth inlet 104ad.

The number of inlets may be formed corresponding to the fans, i.e., two inlets may be formed for one fan.

The first inlet 104aa is connected with the outlet 122a of the rear flow path 120a, such that the air A1 flowed in the rear flow path 120a may flow into the fan unit 100a.

The second inlet 104ab, the third inlet 104ac, and the fourth inlet 104ad are connected with the space between the inner case 11az and the outer case 12az, so that air A2 that has passed through the first inlet hole 41a of the outer case 12az and the first filter 51a may flow into the fan unit 100a.

Accordingly, the cooking apparatus 1a according to another embodiment of the present disclosure further includes a heat dissipation fan 70a and a sub-fan unit 110a compared to the cooking apparatus 1 according to the first embodiment of the present disclosure.

Accordingly, by installing the heat dissipation fan 70a, cooling of the electronics room may be carried out more efficiently.

Furthermore, the air volume of the air A1 flowing through the second inlet hole 42a and the second filter 52a may be increased by the sub fan unit 110a. That is, the amount of air suctioned into the first inlet hole 41a of the cooking apparatus 1a and the amount of air suctioned into the second inlet hole 42a of the cooking apparatus 1a may be more balanced than in the cooking apparatus 1 according to one embodiment of the present disclosure. Therefore, a cooking apparatus 1a having a more improved suction performance may be realized.

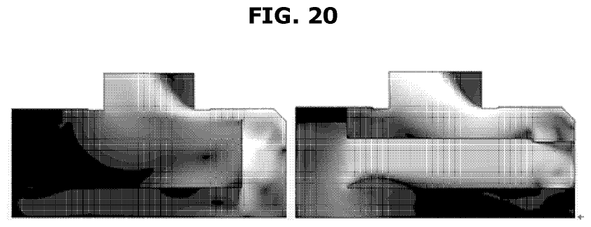

FIG. 20 is a photograph analyzing the air flow distribution with and without the formation of the rear flow path in a cross section along the line A-A′ of FIG. 11.

Referring to FIG. 20, the air flow in the cooking apparatus 1 according to one embodiment of the present disclosure and the cooking apparatus 1a according to another embodiment of the present disclosure will be described in the case with the rear flow path 120 and the case without the rear flow path 120.

The left side of FIG. 20 is an air flow distribution analysis in the case without the rear flow path 120, and the right side of FIG. 20 is an air flow distribution analysis in the case with the rear flow path 120.

Referring to FIG. 20, the amount of air suctioned into the interior of the cooking apparatus 1 in the case where the rear flow path 120 is not formed is less than the amount of air suctioned into the interior of the cooking apparatus 1 in the case where the rear flow path 120 is formed. Also, by forming the rear flow path 120, the speed of the air suctioned into the interior of the cooking apparatus 1 and passing through the rear flow path 120 is faster than in the case where the rear flow path 120 is not formed.

Thus, by forming the rear flow path 120, the suction performance inside the cooking apparatus may be further improved.

Specific embodiments have been shown and described above. However, the disclosure is not limited to the above embodiments, and one having ordinary skill in the art to which the disclosure belongs will be able to make various modifications without departing from the spirit of the technical idea of the disclosure set forth in the following claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A cooking apparatus comprising:
an outer case with a lower surface including a first inlet hole and a second inlet hole;
an inner case accommodated within the outer case and in which a cooking chamber is formed;
a fan disposed on an upper side of the first inlet hole and configured to suction air introduced into the first inlet hole such that air is suctioned through the first inlet hole and the second inlet hole; and
a rear flow path formed at a rear of the inner case in communication with the fan such that air suctioned through the second inlet hole is guided to the fan.

2. The cooking apparatus according to claim 1, further comprising a sub fan in communication with one side of the rear flow path and disposed on an upper side of the second inlet hole such that air passed through the second inlet hole is introduced into the rear flow path.

3. The cooking apparatus according to claim 2, wherein the sub fan is disposed at a rear side of the inner case to be in communication with the rear flow path.

4. The cooking apparatus according to claim 3, wherein one end of the rear flow path is in communication with the fan and the other end of the rear flow path is in communication with the sub fan so that air discharged from the sub fan flows to the fan via the rear flow path.

5. The cooking apparatus according to claim 4, further comprising a combining panel coupled to the fan and forming the one end of the rear flow path in communication with the fan.

6. The cooking apparatus according to claim 5, further comprising a flow path forming panel in contact with a rear wall of the inner case to form the rear flow path,
wherein the combining panel is combined with the flow path forming panel to form the one end of the rear flow path in communication with the fan.

7. The cooking apparatus according to claim 6, wherein:
the flow path forming panel is provided in a plurality, and
the plurality of flow path forming panels includes:
a first flow path forming panel disposed on an upper side of the combining panel, and
a second flow path forming panel disposed on a lower side of the combining panel.

8. The cooking apparatus according to claim 7, wherein an outlet of the sub fan and an inlet of the fan are formed between the first flow path forming panel and the second flow path forming panel.

9. The cooking apparatus according to claim 1, wherein:
the fan includes a plurality of inlets, and
one of the plurality of inlets is in communication with the rear flow path.

10. The cooking apparatus according to claim 9, further comprising:
a first filter mounted on a bottom surface of the outer case to cover the first inlet hole and arranged adjacent to the fan so that a portion of the air passing through the first filter is directly suctioned into the fan; and
a second filter mounted on a bottom surface of the outer case to cover the second inlet hole and arranged spaced apart from the fan so that a portion of the air passing through the second filter is diverted into the rear flow path and suctioned into the fan.

11. The cooking apparatus according to claim 1, wherein the fan is disposed between the outer case and the inner case such that air introduced into the outer case is discharged to outside of the cooking apparatus.

12. The cooking apparatus according to claim 11, further comprising:
a discharge panel disposed on an upper side of the fan, and provided with a hole having a shape corresponding to an outlet of the fan;
a discharge flow path formed between the inner case and the outer case for air discharged from the discharge panel to flow;
a guide panel formed with an upward slope at a corner of the outer case to guide air in the discharge flow path; and
an outlet provided on an upper surface of the outer case for the guided air to flow out of the cooking apparatus.

13. A cooking apparatus comprising:
an inner case forming a cooking chamber;
an outer case accommodating the inner case and having a lower surface including a first inlet hole and a second inlet hole;
a rear flow path formed at a rear of the inner case and configured to guide air suctioned into the second inlet hole;
a flow path forming panel disposed between the inner case and the outer case at the rear to form the rear flow path; and
a fan disposed on an upper side of the first inlet hole between the inner case and the outer case, configured to suction air, which has passed through the first inlet hole, and disposed in communication with the rear flow path to suction air, which has passed through the second inlet hole, through the rear flow path.

14. The cooking apparatus of claim 13, further comprising a sub fan disposed on an upper side of the second inlet hole between the inner case and the outer case.

15. The cooking apparatus of claim 13, further comprising a combining panel, to which the fan is coupled, the combining panel coupled to the flow path forming panel to form one end of the rear flow path that is in communication with the fan.

16. The cooking apparatus of claim 15, wherein:
the flow path forming panel is provided in a plurality, and
the plurality of flow path forming panels includes:
a first flow path forming panel disposed on an upper side of the combining panel, and
a second flow path forming panel disposed on a lower side of the combining panel.

17. The cooking apparatus of claim 16, wherein an outlet of a sub fan and an inlet of the fan are formed between the first flow path forming panel and the second flow path forming panel.

18. The cooking apparatus of claim 17, wherein the inlet of the fan is in communication with one end of the rear flow path and the outlet of the sub fan is in communication with the other end of the rear flow path.

19. A cooking apparatus comprising:
an outer case with a lower surface including a first inlet hole and a second inlet hole;
an inner case accommodated within the outer case and in which a cooking chamber is formed;
a first filter and a second filter mounted on the outer case to cover the first inlet hole and the second inlet hole, respectively;
a fan disposed on an outer side of the inner case such that air passed through at least one of the first inlet hole or the second inlet hole is suctioned; and
a rear flow path formed at a rear of the inner case for air from at least one of the first inlet hole or the second inlet hole to be guided to the fan,
wherein the first inlet hole is arranged adjacent to the fan such that air passing through the first inlet hole is directly suctioned into the fan, and the second inlet hole is arranged at a side of the first inlet hole such that air passing through the second inlet hole is divided to the rear flow path and suctioned into the fan.

20. The cooking apparatus of claim 19, further comprising:
a flow path forming panel disposed at a rear of the inner case to form the rear flow path; and
a sub fan disposed on an upper side of the second inlet hole while in communication with one end of the rear flow path such that air from at least one of the first inlet hole or the second inlet hole flow to the rear flow path.
